(19) United States
(12) Patent Application Publication
(10) Pub. No.: US 2024/0002225 A1
(43) Pub. Date: Jan. 4, 2024

(54) CONTROLLED PRODUCTION OF HYDROGEN AND CARBON BLACK

(71) Applicant: CORIOLIS TECHNOLOGY PARTNERS LLC, Centennial, CO (US)

(72) Inventors: David Hettich, Centennial, CO (US); Benjamin McInnis, Centennial, CO (US)

(21) Appl. No.: 18/039,193

(22) PCT Filed: Nov. 30, 2021
(86) PCT No.: PCT/US2021/061094

§ 371 Date: May 26, 2023

Related U.S. Application Data
(60) Provisional application No. 63/119,461, filed on Nov. 30, 2020.

(51) Int. Cl. C01B 3/24; C09C 1/50; B01J 6/00

(52) U.S. Cl. CPC C01B 3/24; C09C 1/50; B01J 6/008; C01B 2203/0272; C01B 2203/049; C01B 2203/148; C01B 2203/0833; C01B 2203/1241

(57) ABSTRACT

Examples relate to methods and systems for controllably pyrolyzing hydrocarbon feedstock to produce hydrogen gas and carbon black in a continuous flow without fowling the equipment. The methods and systems control the pressure and temperature of the hydrocarbon feedstock to induce pyrolysis at selected positions in the system.

### CROSS-REFERENCE TO RELATED APPLICATIONS

This application claims priority to U.S. Provisional Patent Application No. 63/119,461 filed on 30 Nov. 2020, the disclosure of which is incorporated herein, in its entirety, by this reference.

### BACKGROUND

Thermally decomposing chemical compositions, referred to as pyrolysis, can be an effective way to form reaction products. However, energy needed to reach thermal decomposition temperate of the reactants may be costly. Accordingly, pyrolysis may not be feasible in areas where energy is not readily available or economic for heating the reactants.

The principal chemical reaction for pyrolysis of methane results in the decomposition of methane into its constituent molecules-hydrogen (e.g., H₂ gas) and carbon (e.g., carbon black). Hydrogen gas may be burned as a fuel and carbon black may be utilized in a number of products such as pigments, inks, tires, or a rubber filler.

### SUMMARY

Embodiments disclosed herein are related to devices, systems, and methods for controlled decomposition of hydrocarbon feedstock to produce hydrogen gas and pure carbon black.

In an embodiment, a method for pyrolyzing a hydrocarbon feedstock is disclosed. The method includes elevating a pressure of the hydrocarbon feedstock to an elevated pressure above a decomposition pressure range of the hydrocarbon feedstock. The method includes heating the hydrocarbon feedstock to at least a decomposition temperature of the feedstock at the elevated pressure. The method includes rapidly expanding the heated and pressurized hydrocarbon feedstock to allow pyrolysis to take place to produce hydrogen gas and carbon black.

In an embodiment, a system for pyrolyzing hydrocarbon feedstock is disclosed. The system includes a high pressure pump. The system includes a heat exchanger fluidly connected to the high pressure pump. The system includes one or more rapid expansion valves fluidly connected to the heat exchanger. The system includes a reaction chamber fluidly connected to the one or more rapid expansion valves.

In an embodiment, a method for pyrolyzing a hydrocarbon feedstock is disclosed. The method includes heating a hydrocarbon feedstock to a step-up temperature below a decomposition temperature of the hydrocarbon feedstock. The method includes increasing pressure of the hydrocarbon feedstock to an elevated pressure. The method includes converging streams of the pressurized and heated hydrocarbon feedstock effective to initiate pyrolyzation of the hydrocarbon feedstock to produce hydrogen gas and carbon black.

In an embodiment, a system for pyrolyzing hydrocarbon feedstock is disclosed. The system includes a step-up chamber fluidly connected to a hydrocarbon feedstock supply. The system includes an adiabatic compression chamber fluidly connected to the step-up chamber. The system includes one or more of a plurality of converging jets or a plurality of converging nozzles fluidly connected to the adiabatic compression chamber and arranged to converge multiple streams of hydrocarbon feedstock into one or more focal points.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a block diagram of a system for pyrolyzing a hydrocarbon feedstock, according to an embodiment.

FIG. 2 is a flow chart of a method for pyrolyzing a hydrocarbon feedstock, according to an embodiment.

FIG. 3 is a block diagram of a system for pyrolyzing a hydrocarbon feedstock, according to an embodiment.

FIG. 4 is a flow chart of a method for pyrolyzing a hydrocarbon feedstock, according to an embodiment.

### DETAILED DESCRIPTION

Embodiments disclosed herein are related to systems and methods of continuously pyrolyzing hydrocarbon feedstock, mainly methane therein, by controllably increasing the pressure of the feedstock to retard onset of thermal decomposition until the hydrocarbon feedstock is moved to a selected position in the system. The techniques and systems disclosed herein achieve a large volume controlled reaction without fouling mechanical operations with carbon black and other reaction products. Mechanical operations and equipment in pyrolysis systems suffer from issues such as carbon buildup, carbon fallout, soot or other products from primary undesirable reactions or derivative reactions. Such undesirable materials on the equipment damage, interfere with, or delay desirable primary reactions, such that a materially sustained continuous run of pyrolysis is not achievable. While the methods and systems disclosed herein are described as eliminating fouling of processing equipment (e.g., heat exchangers) by preventing pyrolysis until a selected point in the method or system, it should be understood that a negligible amount of undesired pyrolysis may occur prior to the selected point in the method or system. For example, 10% or less (e.g., less than 5% or even less than 3% by volume) of the total pyrolysis of the hydrocarbon feedstock that will occur at a given temperature may occur in the heat exchanger, high pressure pump, or conduits connected thereto. However, such a negligible amount of pyrolysis products represent a large reduction in fouling materials compared to conventional pyrolysis techniques and systems. Accordingly, preventing 90% or more of the pyrolysis of hydrocarbon feedstock that will occur at a selected temperature is considered preventing pyrolysis for the purposes herein.

In examples, methane gas in a hydrocarbon feedstock is heated until the decomposition temperature is achieved, and hydrogen and carbon black are separated from the unreacted methane. The molar quantities of these materials are governed by the equilibrium of the decomposition reaction which is variably controlled by state properties. At higher temperatures and lower pressures, the equilibrium percentage increases, yielding more products and less reactants. Higher pressures physically hold the molecules together within the hydrocarbon feedstock, which then exhibits higher activation temperatures to initiate the decomposition reaction. At atmospheric pressure, the reaction will begin to occur around 700° C. and reaches highest equilibrium at about 1600° C.

The methods and systems disclosed herein may heat the hydrocarbon feedstock through direct or indirect means but limit formation of pyrolysis products in the heating and pressure control means. The methods and systems disclosed herein provide pyrolysis reactions of hydrocarbon feedstock in a continuous run or flow. The methods and systems disclosed herein achieve a non-catalytic conversion of methane, ethane, or other components in hydrocarbon feedstock to hydrogen and carbon black products. The pyrolysis reaction is controlled through temperature, pressure, and velocity manipulation. The above results are accomplished with nearly no emissions once the process is started and do not directly emit meaningful amounts of carbon dioxide once sufficient output feedstock is available.

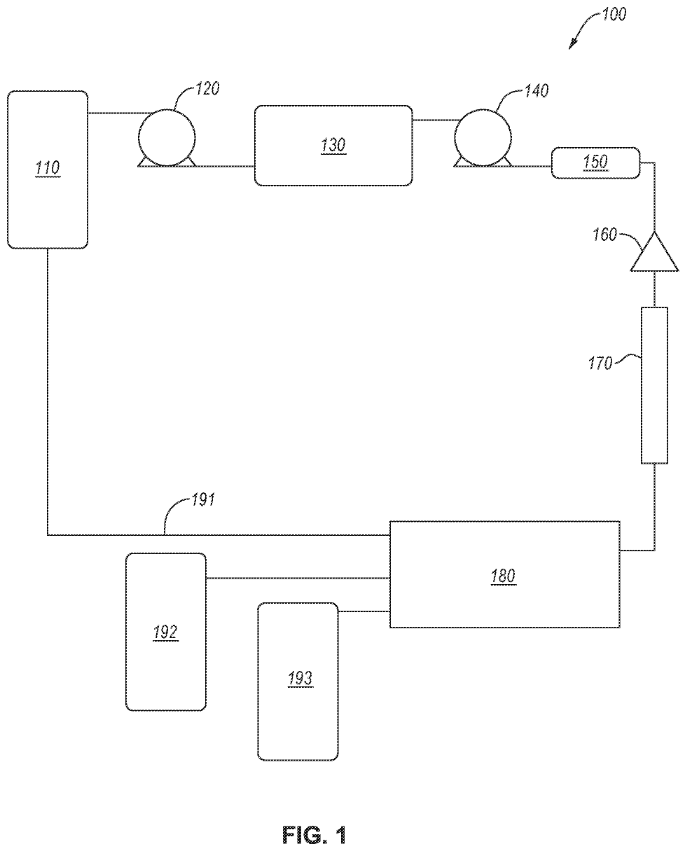

FIG. 1 is a block diagram of a system 100 for pyrolyzing a hydrocarbon feedstock, according to at least one embodiment. The system 100 is used to elevate a pressure of the hydrocarbon feedstock above a decomposition pressure of methane and elevate a temperature of the hydrocarbon feedstock above a decomposition temperature of methane (at the current pressure), and then controllably drop the pressure to a pressure below the decomposition pressure to control decomposition of methane to hydrogen gas and carbon black. The system 100 includes a hydrocarbon feedstock supply 110, a low pressure pump 120, a first heat exchanger 130, a high pressure pump 140, a second heat exchanger 150, a rapid expansion valve 160, a reaction chamber 170, a stagnation tank 180, a recirculation line 191, a hydrogen gas collection tank 192, and a carbon black collection tank 193. The components of the system 100 are fluidly connected to each other directly or via indirect connections such as via one or more pipes, conduits, pressure lines, or other apparatuses. For example, the fluid connections between components includes conduits (e.g., pipes, pressure hoses, or lines) sized, shaped, and composted to withstand the heat and pressures disclosed herein. Each of the components of the system 100 may be connected to previous or subsequent component within the system 100 by one or more fluid tight connections to provide a sealed system.

The hydrocarbon feedstock supply 110 may be fluidly connected to (e.g., directly or indirectly) the high pressure pump 140. For example, the hydrocarbon feedstock supply may be plumped directly to the high pressure pump 140. The high pressure pump 140 may include at least one diaphragm gas compressor, reciprocating piston gas compressor, multi-stage rotary screw gas compressor, radial or centripetal gas compressor, Roots positive displacement gas compressor, or the like to increase the pressure of a hydrocarbon feedstock to above a decomposition pressure of methane in the hydrocarbon feedstock at a current temperature of the hydrocarbon feedstock. The high pressure pump 140 may pressurize the hydrocarbon feedstock to a pressure above a decomposition pressure range of the hydrocarbon feedstock (e.g., methane) at a selected temperature above a decomposition temperature. The high pressure pump 140 may include a plurality of pressure pumps arranged in parallel or series. The high pressure pump 140 is fluidly connected to the second heat exchanger 150 such as via one or more pipes, conduits, pressure lines, or other apparatuses.

The second heat exchanger 150 may be a primary heat exchanger to heat the hydrocarbon feedstock to a temperature above a decomposition temperature. For example, the second heat exchanger 150 may be larger than a first heat exchanger 130 for preheating the hydrocarbon feedstock to an intermediate temperature. The second heat exchanger 150 may be may include a tube and shell heat exchanger, plate and frame heat exchanger, U-tube heat exchanger, or any other heat exchanger. Other heaters may be utilized instead of or in addition to the second heat exchanger 150. The second heat exchanger 150 heats the hydrocarbon feedstock to at least the decomposition temperature of the hydrocarbon feedstock (e.g., methane), such as 700° C.-2,000° C.

The second heat exchanger 150 is fluidly connected to one or more rapid expansion valves 160, such as via one or more pipes, conduits, pressure lines, or other apparatuses. The one or more rapid expansion valves 160 may include one or more of converging-diverging nozzles, thermostatic expansion valves, constant-pressure expansion valves, or the like. The rapid expansion valves 160 are sized and shaped to allow flow the of the heated and pressurized feedstock therethrough at a rate sufficient to allow the heated and pressurized hydrocarbon feedstock that passes therethrough to rapidly decompress sufficient to allow pyrolysis to take place and to maintain pressure above of the heated and pressurized hydrocarbon feedstock in the heat exchanger 150 to maintain the elevated pressure above the decomposition pressure at the elevated temperature. For example, the space velocity of hydrocarbon feedstock flowing through the one more expansion valves (depending upon system size) may range from 2 units/sec. to 40 units/sec. Accordingly, the rapid expansion valves 160 prevent drop of pressure in the second heat exchanger 150 and allow the pressure of the heated and pressurized hydrocarbon feedstock to drop below a decomposition pressure sufficient to allow pyrolysis to take place downstream of the rapid expansion valves.

The rapid expansion valves 160 are positioned to vent hydrocarbon feedstock into a reaction chamber 170 to allow the pyrolysis reaction of the hydrocarbon feedstock (e.g., methane or ethane) to progress. The rapid expansion valves 160 may be directly mounted on or indirectly coupled to the second heat exchanger 150, such as at a distal end thereof to induce pyrolysis as quickly as possible after heating in the second heat exchanger 150. The rapid expansion valves 160 may be fluidly connected to the second heat exchanger via one or more conduits therebetween, such as relatively short conduits (e.g. 0.3 meters or less). Accordingly, the pyrolysis reaction of at least methane in the hydrocarbon feedstock carried out in the system 100 is selectively controlled to take place in the reaction chamber 170 via manipulation of temperature and pressure. The reaction chamber 170 is the vessel defining the volume after the expansion process. The reaction chamber 170 is the equipment space in the system 100 where the pyrolysis reaction will largely occur. The reaction chamber 170 has a larger volume than the rapid expansion valves 160. The diameter and volume of reaction chamber 170 is larger than the conduit(s) feeding (e.g., pipe prior to) the one or more rapid expansion valves 160 to mechanically reduce the pressure of the hydrocarbon feedstock passing therethrough.

The reaction chamber 170 is fluidly connected to the stagnation tank 180, either directly or indirectly (e.g., through one or more conduits). The stagnation tank 180 may include a settling or collection tank that is fluidly sealed to prevent air from passing into the interior volume thereof. The volume of the stagnation tank 180 may be much higher (e.g., at least 2 times larger) than the volume of the reaction chamber 170. The stagnation tank 180 may include a plurality of baffles therein. The baffles may provide for a selected amount of residence time in the stagnation tank, sufficient to allow the carbon black to separate from the hydrogen gas and any unreacted hydrocarbon feedstock. The stagnation tank 180 allows the mixture of products from pyrolysis of the hydrocarbon feedstock (e.g., methane) to come to rest allowing the hydrogen gas and leftover methane to separate by densities through diffusion. It may be helpful to perform separation of carbon black from hydrogen gas at a temperature above the minimum pyrolysis temperature of the hydrocarbon feedstock, such as 700° C.-1600° C., to prevent back conversion of carbon black and methane to hydrogen. Accordingly, one or both of the reaction chamber 170 or the stagnation tank 180 may be heated or connected to a heat exchanger.

The stagnation tank 180 may be fluidly connected to one or more of the hydrocarbon feedstock supply 110, a hydrogen gas collection tank 192, or a carbon black collection tank 193. For example, the stagnation tank 180 may be connected to the hydrogen gas collection tank 192 at an upper portion of the stagnation tank 180 and connected to the carbon black collection tank 193 at a lower portion of the stagnation tank 180. As the pyrolysis reaction progresses, solid carbon black falls form the hydrogen gas and unreacted hydrocarbon feedstock (if present) to the bottom of the stagnation tank 180. In some examples, the carbon black may be collected directly from the stagnation tank 180, such as via a conveyor, gravity feed, or the like to the carbon black collection tank 193.

The stagnation tank 180 may be fluidly connected to the hydrocarbon feedstock supply 110 via the recirculation line 191. For example, a conduit for the recirculation line may be located on the stagnation tank 180 at a point lower than where the hydrogen gas collection tank 192 is connected to collect the unreacted hydrocarbon feedstock which is heavier than hydrogen. The unreacted hydrocarbon feedstock is recirculated back to the hydrocarbon feedstock supply 110 via the recirculation line 191 to allow the unreacted hydrocarbon feedstock to be reprocessed.

In some examples, the hydrocarbon feedstock supply 110 is indirectly connected to the second high pressure pump 140, via one or both of a low pressure pump 120 or a first heat exchanger 130. The low pressure pump 120 may include at least one diaphragm gas compressor, reciprocating piston gas chamber, multi-stage rotary screw gas compressor, radial or centripetal gas compressor, a Roots positive displacement gas compressor, or the like. The low pressure pump 120 may pre-pressurize the hydrocarbon feedstock to an intermediate pressure prior to elevated the pressure of the hydrocarbon feed stock to a pressure above a decomposition pressure range of the hydrocarbon feedstock (e.g., methane). The first heat exchanger 130 may include a tube and shell heat exchanger, plate and frame heat exchanger, U-tube heat exchanger, or any other heat exchanger. Other heaters may be utilized instead or in addition to the first heat exchanger 130. The first heat exchanger 130 may pre-heat the hydrocarbon feedstock to an intermediate temperature below the decomposition temperature of the hydrocarbon feedstock (e.g., methane), such as 100° C.-500° C.

One or more portions of the system 100 may provide inputs or outputs from outside of the system 100. For example, the hydrocarbon feedstock supply 110 may include an inlet for receiving hydrocarbon feedstock from a source outside of the system 100. The stagnation tank 180 or the carbon black collection tank 193 may include an access port for removing the carbon black form the system 100. Similarly, the hydrogen gas collection tank 192 may include an outlet valve for outputting the hydrogen gas from the system 100. One or all of the carbon black collection tank 193, the stagnation tank 180, or the reaction chamber 170 may be heated to prevent back conversion of carbon black and hydrogen to methane.

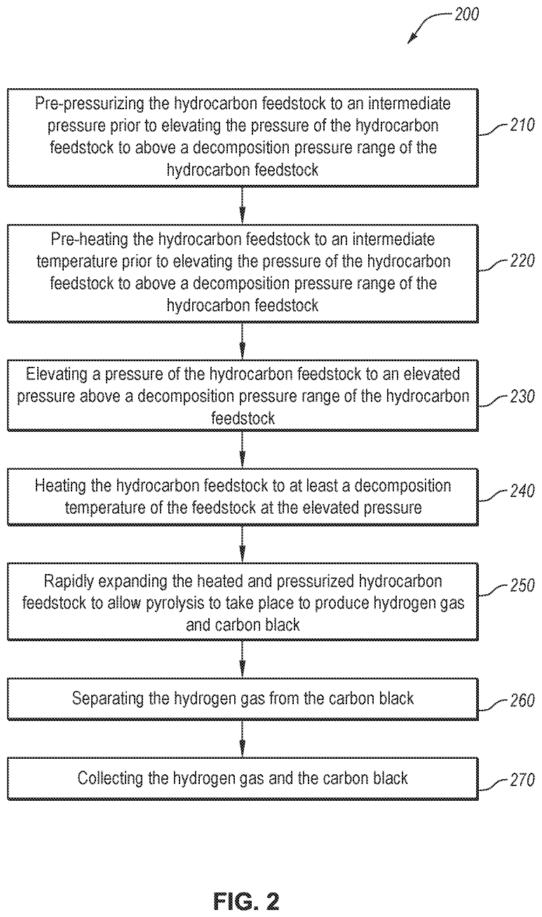

The system 100 is used to controllably pyrolyze hydrocarbon feedstock containing methane to prevent fouling of the components therein with carbon black. In a first embodiment, a method of pyrolyzing a hydrocarbon (e.g., methane) feedstock is disclosed. FIG. 2 is a flow diagram of a method 200 for pyrolyzing a hydrocarbon feedstock. The method 200 includes a block 210 of pre-pressurizing the hydrocarbon feedstock to an intermediate pressure prior to elevating the pressure of the hydrocarbon feedstock to above a decomposition pressure range of the hydrocarbon feedstock; a block 220 of pre-heating the hydrocarbon feedstock to an intermediate temperature prior to elevating the pressure of the hydrocarbon feedstock to above a decomposition pressure range of the hydrocarbon feedstock; a block 230 of elevating a pressure of the hydrocarbon feedstock to an elevated pressure above a decomposition pressure range of the hydrocarbon feedstock; a block 240 of heating the hydrocarbon feedstock to at least a decomposition temperature of the feedstock at the elevated pressure; a block 250 of rapidly expanding the heated and pressurized hydrocarbon feedstock to allow pyrolysis to take place to produce hydrogen gas and carbon black; a block 260 of separating the hydrogen gas from the carbon black; and a block 270 of collecting the hydrogen gas and the carbon black. One or more blocks of the method 200 may be combined, omitted, or reordered. For example, the method 200 may include blocks 230-250, where blocks 210, 220, 260, or 270 are optional. Additional blocks may be included in the method 200. The method 200 is carried out continuously without the risk of fouling heating apparatuses, pressure pumps, valves, or conduits with carbon black.

The block 210 of pre-pressurizing the hydrocarbon feedstock to an intermediate pressure prior to elevating the pressure of the hydrocarbon feedstock to above a decomposition pressure range of the hydrocarbon feedstock includes pressurizing the hydrocarbon feedstock (e.g., methane) from an initial pressure to an intermediate pressure. The intermediate pressure may be any pressure below 1,000 psi (6.89 MPa), such as 15 psi (0.1 MPa) to 1,000 psi, 100 psi (0.69 MPa) to 500 psi (3.45 MPa), or 300 psi (2.07 MPa) to 700 psi (4.83 MPa), or 700 psi to 900 psi (6.2 MPa), less than 900 psi, or less than 500 psi. Pre-pressurizing the hydrocarbon feedstock may be carried out in a low pressure pump or compressor as disclosed herein. For example, the low pressure pump 120 (FIG. 1) may be used to pressurize the hydrocarbon feedstock to the intermediate temperature.

The block 220 of pre-heating the hydrocarbon feedstock to an intermediate temperature prior to elevating the pressure of the hydrocarbon feedstock to above a decomposition pressure range of the hydrocarbon feedstock may include heating the hydrocarbon feedstock to a temperature below 500° C., such as 100° C. to 500° C., 100° C. to 250° C., 250° C. to 500° C., less than 400° C., or less than 250° C. The pre-heating may be carried out with the first heat exchanger 130 (FIG. 1) as disclosed herein above. Pre-heating the hydrocarbon feedstock to an intermediate temperature includes heating the hydrocarbon feedstock with ambient pressure or an intermediate pressure.

The block 230 of elevating a pressure of the hydrocarbon feedstock to an elevated pressure above a decomposition pressure range of the hydrocarbon feedstock includes pressurizing (e.g., compressing) the hydrocarbon feedstock to a pressure of at least 100 psi or at least 1,000 psi (6.89 MPa), such as 1,000 psi (6.89 MPa) to 2,000 psi (13.79 MPa), 1,200 psi (8.27 MPa) to 1,600 psi (11.03 MPa), 1,600 psi (11.03 MPa) to 2,000 psi (13.79 MPa), at least 1,500 psi (10.34 MPa), or at least 2,000 psi (13.79 MPa). Higher pressures are favorable because the larger the pressure difference across the rapid expansion valve(s) the larger the shift of equilibrium is observed toward pyrolysis products. The decomposition pressure range may be a range of pressure of the hydrocarbon feedstock, at an elevated temperature, where decomposition takes place. Elevating the pressure of the hydrocarbon feedstock to above the decomposition pressure range of the hydrocarbon feedstock includes pressurizing the hydrocarbon feedstock with a high pressure pump 140 (FIG. 1) as disclosed above. The hydrocarbon feedstock may be provided to the high pressure pump from a hydrocarbon feedstock supply, either directly or indirectly. For example, one or both of blocks 210 and 220 may be omitted from the method 200.

The block 240 of heating the hydrocarbon feedstock to at least a decomposition temperature of the feedstock at the elevated pressure includes heating the hydrocarbon feedstock to a decomposition temperature of methane in the hydrocarbon feedstock. The block 240 of heating the hydrocarbon feedstock to at least a decomposition temperature of the feedstock at the elevated pressure includes heating the pressurized hydrocarbon feedstock to a temperature of at least 700° C., such as 700° C. to 2000° C., 700° C. to 1,200° C., 1,200° C. to 1,500° C., 1,500° C. to 2000° C., at least 1,000° C., at least 1,300° C., or at least 1,600° C. The temperature at which methane begins decomposition at atmospheric pressure is approximately 700° C. The yield of the pyrolysis reaction of methane in the hydrocarbon feedstock is controlled by raising the temperature of the hydrocarbon feedstock to a higher temperature than is possible at atmospheric pressure without initiating the pyrolysis reaction (atmospheric pyrolysis temperature) by first elevating the pressure of the hydrocarbon feedstock prior to raising the temperature above the atmospheric pyrolysis temperature. For example, as the pressure is raised in the hydrocarbon feedstock, the temperature necessary to initiate pyrolysis also increases. Such temperature control increases the yield of hydrogen gas and carbon black from the methane on a per mass flow basis compared to the same reaction without the increased pressure and temperature.

Heating the hydrocarbon feedstock to at least a decomposition temperature of the feedstock at the elevated pressure includes heating the pressurized hydrocarbon feedstock with a heat exchanger, an oven, or any other heating device disclosed herein. At this stage of the method 200, the elevated pressure (above the decomposition pressure range) is maintained to prevent initiation of pyrolysis of the hydrocarbon feedstock at the elevated temperature. Such control prevents fowling of the pressure pump(s), heat exchanger(s), and subsequent conduits with carbon black produced from the pyrolysis reaction of methane in the hydrocarbon feedstock.

The block 250 of rapidly expanding the heated and pressurized hydrocarbon feedstock to allow pyrolysis to take place to produce hydrogen gas and carbon black includes flowing the heated and pressurized hydrocarbon feedstock through one or more rapid expansion valves. The rapid expansion valves may include any of the rapid expansion valves disclosed herein such as converging diverging nozzles, thermostatic expansion valves or constant-pressure expansion valves, or the like. The rapid expansion valves may be insulated.

Block 250 is the initiation of the pyrolysis reaction of the hydrocarbon feedstock and a control component of the reaction. In this block, the heated, pressurized hydrocarbon feedstock is rapidly, adiabatically decompressed to a pressure below the decomposition activation pressure (e.g., within the decomposition pressure range). This rapid decrease in pressure ensures that in a small time (e.g., several milliseconds) the hydrocarbon feedstock changes from existing in a state above the decomposition parameters to a state within the decomposition parameters of the hydrocarbon feedstock or components thereof such as methane. This drop in pressure cause the pyrolysis reaction to occur in-stream, at a selected location, at a greatly reduced residence time (compared to lower pressure or lower temperature reactions), while gaining the benefits of high temperature decomposition. For example, methane pyrolyzes to produce hydrogen gas and carbon black as the pressure drops into the decomposition pressure range of methane at the decomposition temperature. The same reaction may take place for ethane or other hydrocarbons present in the hydrocarbon feedstock. The rapid expansion provides increased chemical equilibrium toward and yields larger molar quantities of primary products (hydrogen gas and carbon black) per cubic meter per second of hydrocarbon feedstock than lower pressure or lower temperature pyrolysis. The rapid change in pressure results in high velocity flow as the high pressure is being converted into kinetic and thermal energy.

In examples, rapidly expanding the heated and pressurized hydrocarbon feedstock to allow pyrolysis to take place to produce hydrogen gas and carbon black includes flowing the heated and pressurized hydrocarbon feedstock into a reaction chamber. The reaction chamber 170 (FIG. 1) may be directly or indirectly connected to the rapid expansion valves. For example, the rapid expansion valves may vent into a reaction chamber to allow the pyrolysis reaction to progress. Accordingly, the pyrolysis reaction is selectively controlled to take place in the reaction chamber via manipulation of temperature and pressure of the hydrocarbon feedstock. The velocities of the flow of hydrocarbon feedstock or pyrolyzed products thereof are lowered to a more manageable value in the reaction chamber than is present in the rapid expansion valve(s).

In a simplest example, the method 200 only includes the blocks 230, 240, and 250. However, further blocks may be utilized to separate and collect the hydrogen and carbon black products of pyrolysis of the hydrocarbon feedstock.

The block 260 of separating the hydrogen gas from the carbon black may include allowing the carbon black to fall or otherwise separate from the hydrogen gas and any unreacted hydrogen feedstock. Separating the hydrogen gas from the carbon black includes allowing the carbon black to fall from hydrogen gas. For example, separating the hydrogen gas from the carbon black may include flowing the rapidly expanded hydrocarbon feedstock into a stagnation tank and allowing the carbon black to fall from hydrogen gas (and any other gases such as unreacted hydrocarbon feedstock) in the stagnation tank. The stagnation tank may include any of the stagnation tanks 180 (FIG. 1) disclosed herein. The stagnation tank allows the mixture of products from pyrolysis of the hydrocarbon feedstock (e.g., methane) to come to rest allowing the hydrogen gas and leftover methane to separate by densities through diffusion. The carbon black will have fallen out of suspension to the bottom of the stagnation tank. Separating the hydrogen gas from the carbon black may be performed at a temperature above the minimum pyrolysis temperature of the hydrocarbon feedstock to prevent back conversion of carbon black and methane to hydrogen. In some example, separating the hydrogen gas from the carbon black includes separating the hydrogen gas from the carbon black at a temperature of at least 700° C., such as 700° C.-1,600° C., 700° C.-1,000° C., 1,000° C.-1,300° C., or 1,300° C.-1,600° C. Separating the hydrogen gas from the carbon black may include heating one or both of the reaction chamber or stagnation tank.

Due to the disparity of densities between the hydrogen gas and methane (or other components of the hydrocarbon feedstock), the hydrogen gas will rise to the top of the stagnation tank and the unreacted hydrocarbon feedstock (e.g., methane) will occupy the lower portion of the stagnation tank allowing for siphoning off of the separate gases in a continuous process. By performing the separation at temperatures above the pyrolysis temperature of methane, the hydrogen and carbon black may be separated and removed from the stagnation tank without back reaction to methane. The separation may be carried out with a screen or filter to separate carbon black from gases in the stagnation tank or collection chamber.

The block 270 of collecting the hydrogen gas and the carbon black includes collecting the hydrogen gas and the carbon black separately. The block 270 of collecting the hydrogen gas and the carbon black may include syphoning hydrogen from an upper portion of the stagnation tank and collecting the carbon black from a bottom of the stagnation tank. Collecting the hydrogen gas includes siphoning the hydrogen gas from the upper portion of the stagnation tank, such as through a hydrogen collection valve and/or tank fluidly connected thereto. Collecting the carbon black includes collecting the carbon black from the bottom of the stagnation tan, such as via dumping the stagnation tank into a carbon black collection tank fluidly connected thereto. The hydrogen gas may be stored in a hydrogen gas collection tank 192 (FIG. 1) and the carbon black may be stored in a separate carbon black collection tank 193 (FIG. 1).

The method 200 is a recirculating loop of hydrocarbon decomposition, in which, hydrocarbon feedstock is added to the system as the reactant. The hydrocarbon feedstock may be pure methane. The hydrocarbon feedstock may also include ethane or other hydrocarbon components in minimal quantities, such as less than 10 volume % of the hydrocarbon feedstock. In some examples, the hydrocarbon feedstock includes drill rig vent gases or well head vent gases, where the gases may be processed to include the above percentages of methane.

Pure hydrogen gas and pure carbon black may be produced as the primary products of the method 200. The hydrogen gas and carbon black are extracted as the products of the reaction and any unreacted hydrocarbon feedstock is recirculated into the initial feedstock to be reused. The reaction will occur until an equilibrium is reached leaving a portion of unreacted methane feedstock in gaseous mixture with the hydrogen.

The method 200 may not pyrolyze all of the methane in the hydrocarbon feedstock as noted above. The unreacted hydrocarbon feedstock may be collected, such as siphoned from the lower portion of the stagnation tank after the unreacted hydrocarbon(s) (e.g., methane) has settled from the hydrogen gas above. The unreacted hydrocarbons may be reused. The method 200 may include recirculating unreacted hydrocarbon feedstock to a hydrocarbon feedstock supply for reuse, such as for recirculation through the method 200. For example, the unreacted hydrocarbon feedstock may be directed back for pressurizing to above a decomposition pressure range of the hydrocarbon feedstock, heating the hydrocarbon feedstock to at least a decomposition temperature of the feedstock at the elevated pressure, and rapidly expanding the heated and pressurized hydrocarbon feedstock to allow pyrolysis to take place to produce hydrogen gas and carbon black. For example, the methane can be recirculated to the hydrocarbon feedstock supply 110 (FIG. 1). An optional block of recirculating any unreacted hydrocarbon feedstock to the hydrocarbon feedstock supply may include recirculating the unreacted hydrocarbon feedstock to the hydrocarbon feedstock supply via a recirculation line fluid connected to the stagnation tank.

The method 200 is carried out continuously without fouling heating apparatuses and pressure pumps with carbon black. The hydrocarbon feedstock is supplied in a continuously available stream and is compressed to an elevated pressure in a continuous stream. Such adiabatic compression provides increased efficiency of later heat addition to the compressed hydrocarbon feedstock and provides control over the later decomposition reaction (e.g., pyrolysis). Because isobaric heat addition to above a decomposition temperature is the next stage, the pressure is elevated above the decomposition pressure range at the decomposition temperature so that, at the next stage, the decomposition reaction (e.g., pyrolysis) will not occur above a negligible amount even though the temperature will be above the atmospheric decomposition temperature. For example, at least 90% (e.g., at least 95% or even at least 97%) of the pyrolysis of the hydrocarbon feedstock (e.g., methane therein) that will occur at a given temperature takes place in the reaction chamber rather than the heat exchanger because the elevated pressure of the hydrocarbon feedstock. Such limitation of the pyrolysis is considered prevention of pyrolysis to below a negligible amount for the purposes herein. The pressure manipulation controls the location of the decomposition reaction and reduces the residence time of the reaction.

Each block of the method 200 is carried out continuously. Such continuous operation is not possible without elevating the pressure of the hydrocarbon feedstock to above the decomposition pressure range (taking into the temperature of the hydrocarbon feedstock) to prevent pyrolysis (e.g., pyrolysis above a negligible amount) until the pressure is lowered.

Continuous pyrolysis of hydrocarbon feedstock may be accomplished differently than disclosed above with respect to FIGS. 1 and 2.

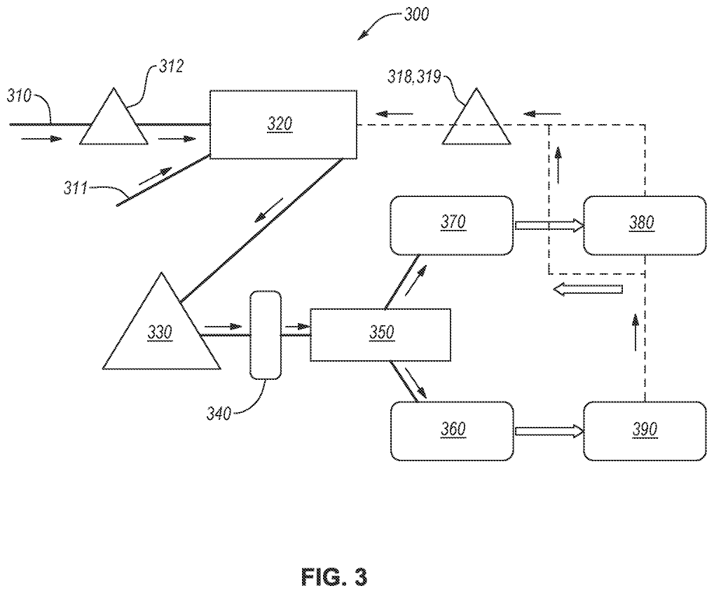

FIG. 3 is block diagram of a system 300 for pyrolyzing hydrocarbon feedstock. The system 300 includes an inlet 310 (e.g., feed line) fluidly connected to a step-up chamber 320. An optional pressure pump 312 may be disposed between and fluidly connected to the inlet 310 and the step-up chamber 320. An optional, additional gas line may be fluidly connected to the inlet 310. An optional accelerant gas addition 311 may be fluidly connected to the step-up chamber 320. The step-up chamber 320 is fluidly connected to the main adiabatic compression chamber 330 (e.g., insulated compression device). The main adiabatic compression chamber 330 is fluidly connected to the stagnation tank 350. An optional post-adiabatic compression manipulation apparatus 340 for manipulating the velocity and compression of the hydrocarbon feedstock may be fluidly connected to, and between, the main adiabatic compression chamber 330 and the stagnation tank 350. The stagnation tank 350 is fluidly connected to a solids and heavy gas catch 360 and a light element catch 370. The solids and heavy gas catch 360 is fluidly connected to solids processing and heavy gas reprocessing equipment 390. The light element catch 370 is fluidly connected to gas processing and refinement equipment 380. The solids processing and heavy gas reprocessing equipment 390 is fluidly connected to one or more of a pressure reducer 318 and residence tank 319 for reprocessing unreacted hydrocarbon feedstock. The one or more of a pressure reducer 318 and residence tank 319 is fluidly connected to the step-up chamber 320 to recirculate the unreacted hydrocarbon feedstock back through the system 300. The fluid connections between components includes conduits (e.g., pipes, pressure hoses, or lines) sized, shaped, and composted to withstand the heat and pressures disclosed herein.

The inlet 310 may be fluidly connected to a hydrocarbon feedstock supply. The optional pressure pump 312 may be similar or identical to any of the pumps disclosed herein, such as a compressor or pump as disclosed with respect to the system 100.

The step-up chamber 320 may be similar or identical to any of the heat exchangers or heaters disclosed herein. The step-up chamber 320 may include or contain any of the heat exchangers or heaters disclosed herein, such as an indirect heat exchanger or the like. The step-up chamber 320 may include an accelerant gas addition 311 fluidly connected thereto if gas density or compression equipment within the system 300 is insufficient to reach a selected pressure. For example, accelerant gas may be used as an additional medium, which, assists in the compression of the hydrocarbon feedstock if the pressures required for the function system 300 and method 400 cannot be achieved with only hydrocarbon feedstock due to inadequate gas density or compression equipment. Such inert gas would only be used for mechanical efficiency and would not have a chemical action in the system and pyrolysis process. For example, the accelerant gas may include inert or noble gases (e.g., neon, argon, xenon) or any other gas that would not react with the reactants, products, or any intermediate molecule formed during the pyrolysis of methane. The accelerant gas may include any inert gas which that can be collected at the end of the system or the pyrolysis process in the same mass as was added, and in the same state it was added.

The main adiabatic compression chamber 330 (e.g., insulated compression device) may include an insulated compressor (e.g., insulated axial or centrifugal compressor) in which heat lost to the atmosphere is negligible and can be ignored in a mathematical model of the methods disclosed herein. Hydrocarbon feedstock from the main adiabatic compression chamber 330 may be output to the stagnation tank 350, such as via the optional post-adiabatic compression manipulation apparatus 340.

The optional post-adiabatic compression manipulation apparatus 340 may include a plurality of converging jets or converging nozzles arranged to converge multiple streams of the hydrocarbon feedstock into a focal point or multiple focal points. The plurality of converging jets or converging nozzles may be directly attached or plumbed to the main adiabatic compression chamber 330. The jetting or convergent nozzling is used to increase the temperature of the hydrocarbon feedstock through mechanical means. For example, the separate flows of hydrocarbon feedstock are converged to heat the hydrocarbon feedstock. The convergence of two gaseous, high-velocity streams converts high velocity kinetic energy into heat. This rapid increase in heat, as well as a pressure drop through a nozzle, increases the temperature to above the decomposition temperature and places the pressure into the decomposition pressure range to initiate pyrolysis, and decreases residence time. The hydrocarbon feedstock (e.g., methane) undergoes pyrolysis upon the temperature increase and the pressure drop after exiting the compression manipulation apparatus 340 and entering the stagnation tank 350.

The stagnation tank 350 may be similar or identical to the stagnation tank 180 (FIG. 1). The stagnation tank 350 is sized, shaped, and arranged to allow the pyrolysis reaction to progress and to allow separation of the hydrogen and carbon black products of the pyrolysis reaction.

The stagnation tank 350 is located after the main adiabatic compression chamber 330 and the optional adiabatic compression manipulation apparatus 340. The pressure and temperature of the stagnation tank 350 is relatively similar, if not the same, as the exit parameters of the main adiabatic compression chamber 330. Accordingly, the optional adiabatic compression manipulation apparatus 340 may be omitted in some examples.

The stagnation tank 350 is fluidly connected to the solids and heavy gas catch 360 and light element catch 370. The solids and heavy gas catch 360 may be similar or identical to the carbon black collection tank 193 disclosed herein. For example, the solids and heavy gas catch 360 may include a fluid tight container attached to the stagnation tank 350 at a height below the height therein that hydrogen gas is located and below a height that a unreacted hydrocarbon feedstock settles within the stagnation tank 350.

The light element catch 370 may be similar or identical to the hydrogen gas collection tank 192 or hydrocarbon feedstock recirculation 291 (FIG. 1) disclosed herein. For example, the light element catch 370 may include a tank and fluid connections thereto for holding gas products. The light element catch 370 may be fluidly connected at an upper portion of the stagnation tank 350, such as to prevent capture of heavier unreacted hydrocarbon feedstock and carbon black, which fall to the lower region of the stagnation tank 350.

The gas processing and refinement equipment 380 may include a hydrogen gas refinement apparatus or system to separate light gases from hydrogen gas to produce substantially pure hydrogen gas. The gas processing and refinement equipment 380 may include a recirculation line fluidly coupled to the step-up chamber 320 to recycle any unreacted hydrocarbon feedstock through the system 300. The gas processing and refinement equipment 380 includes a connection to a hydrogen gas output (e.g., hydrogen storage tank or output line).

The processing and heavy gas reprocessing equipment 390 may include equipment for recirculating unreacted hydrocarbon feedstock to the step-up chamber 320 and outputting carbon black from the system 300. The processing and heavy gas reprocessing equipment 390 may include equipment for separating heavy gas from solids formed in the pyrolysis reaction of the hydrocarbon feedstock (e.g., formation of hydrogen gas and carbon black from methane). The processing and heavy gas reprocessing equipment 390 may include equipment for outputting the carbon black from the system 300, such as an access door, vent, chute, conveyor, or the like.

The solids processing and heavy gas reprocessing equipment 390 is fluidly connected to one or more of a pressure reducer 318 and residence tank 319 for reprocessing unreacted hydrocarbon feedstock through the system 300. The pressure reducer 318 may include one or more valves or conduits having decreasing diameter to drop the pressure of the hydrocarbon feedstock from a line pressure exiting the solids processing and heavy gas reprocessing equipment 390 (e.g., 100 psi) to a pressure of the hydrocarbon feedstock in the step-up chamber or a feed supply (e.g., 20 psi (0.14 MPa)). The residence tank 319 may include a fluid tight tank for storing unreacted hydrocarbon feedstock or any other gas therethrough. The one or more of a pressure reducer 318 and residence tank 319 is fluidly connected to the step-up chamber 320 to recirculate the unreacted hydrocarbon feedstock back through the system 300.

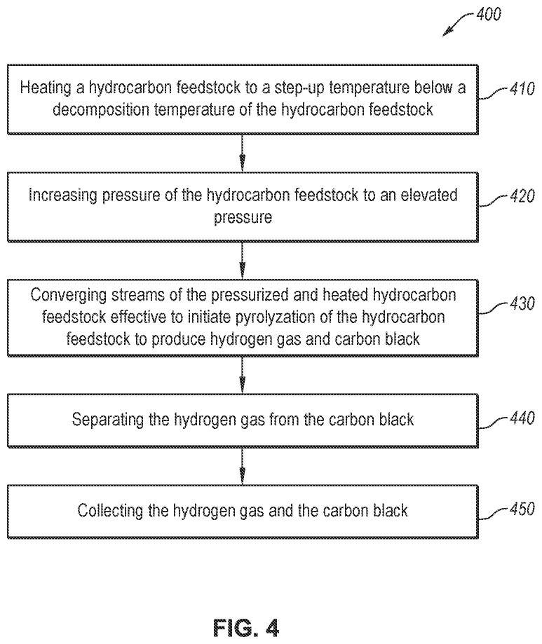

The system 300 is used to controllably pyrolyze one or more components of hydrocarbon feedstock (e.g., methane) by selective manipulation of pressure and temperature of the hydrocarbon feedstock. FIG. 4 is a flow diagram of a method 400 for pyrolyzing a hydrocarbon feedstock. The method 400 includes a block 410 of heating a hydrocarbon feedstock to a step-up temperature below a decomposition temperature of the hydrocarbon feedstock; a block 420 of increasing pressure of the hydrocarbon feedstock to an elevated pressure; a block 430 of converging streams of the pressurized and heated hydrocarbon feedstock effective to initiate pyrolyzation of the hydrocarbon feedstock to produce hydrogen gas and carbon black; a block 440 of separating the hydrogen gas from the carbon black; and a block 450 of collecting the hydrogen gas and the carbon black. One or more blocks 410-450 of the method 400 may be combined, omitted, or reordered. For example, the method 400 may include blocks 410-430, where blocks 440-450 are optional. Additional blocks may be included in the method 400. The method 400 is carried out continuously without the risk of fouling heating apparatuses, pressure pumps, valves, or conduits with carbon black. The method 400 may be carried out using the system 300.

The block 410 of heating a hydrocarbon feedstock to a step-up temperature below a decomposition temperature of the hydrocarbon feedstock includes heating the hydrocarbon feedstock (e.g., methane, ethane, or mixtures thereof) to a temperature above an ambient temperature but below the decomposition initiation temperature of the components of the hydrocarbon feedstock (e.g., below 700° C., 25° C. to 500° C.). Heating a hydrocarbon feedstock may be carried out in a step-up chamber 320 (FIG. 3), such as by an indirect heat exchanger. The heat addition results in elevated line pressures between the step-up chamber 320 and the adiabatic compression chamber 330 (FIG. 3). This heat addition phase brings the hydrocarbon feedstock to an elevated temperature that is below the state's decomposition activation temperature, to ensure the pyrolysis reaction does not occur at this block. Flow of the hydrocarbon feedstock may be selectively controlled into the step-up chamber 320 by further compression of the hydrocarbon feedstock over the inlet 310 (e.g., via the pump 312).

The block 420 of increasing the pressure of the hydrocarbon feedstock to an elevated pressure includes compressing the hydrocarbon feedstock. Block 420 of increasing the pressure of the hydrocarbon feedstock to an elevated pressure includes compressing the hydrocarbon feedstock increasing the pressure of a at least 100 psi, at least 500 psi, at least 1,000 psi, 100 psi to 500 psi, 500 psi to 1,000 psi, at least 500 psi, or 1,000 psi or less.

Block 420 of increasing the pressure of the hydrocarbon feedstock to an elevated pressure may include increasing the temperature of the hydrocarbon feedstock to a temperature above the step-up temperature, such a temperature as nearer or above a decomposition temperature of the hydrocarbon feedstock. Increasing temperature of the hydrocarbon feedstock to a temperature above the step-up temperature includes increasing the temperature of the hydrocarbon feedstock may include increasing the temperature form the step-up temperature to at least 100° C., at least 500° C., at least 1,000° C., 100° C. to 500° C., 300° C. to 700° C., or at least 700° C.

Increasing pressure of the hydrocarbon feedstock to an elevated pressure includes performing adiabatic compression of the hydrocarbon feed stock. For example, increasing the pressure and temperature of the hydrocarbon feedstock is accomplished via adiabatic compression, such as through means for compression other than restricted chamber compression (e.g., reciprocating engines or similar piston actuated compression) where the hydrocarbon feedstock is rapidly compressed. Such means for compression may include an adiabatic compressor (e.g., axial or centrifugal compressor). As the hydrocarbon feedstock is compressed, the temperature, pressure, and velocity of the hydrocarbon feedstock are increased compared to the hydrocarbon feedstock input into the main adiabatic compression chamber 330 (FIG. 3). The hydrocarbon feedstock exit parameters, including temperature (e.g., at least 500° C., at least 700° C.) and pressure (above atmospheric), are sufficient to sustain active decompression of the hydrocarbon feedstock in unconstrained conditions. The temperature and pressure of the hydrocarbon feedstock in the main adiabatic compression chamber 330 are controlled to a level such that the pyrolysis reaction (decomposition) is not instantaneous or very near instantaneous, with a chemical reaction residence time given the exiting hydrocarbon feedstock temperature and pressure, sufficient such that given the hydrocarbon feedstock velocity, decomposition does not occur or have time to occur in the main adiabatic compression chamber 330. For example, the output of the main adiabatic compression chamber 330 may be input into the stagnation tank 350 (FIG. 3) to allow pyrolysis to take place as the hydrocarbon feedstock expands, the pressure thereof drops, and the temperature remains above the decomposition initial temperature of the hydrocarbon feedstock.

Flows of hydrocarbon feedstock may be selectively controlled into the main adiabatic compression chamber 330, such as via one or more valves or control of upstream pressure of the hydrocarbon feedstock, such as via the step up chamber 320 and/or inlet 310.

The block 430 of converging streams of the pressurized and heated hydrocarbon feedstock effective to initiate pyrolyzation of the hydrocarbon feedstock to produce hydrogen gas and carbon black includes routing the heated and pressurized hydrocarbon feedstock from the main adiabatic compression chamber 330 into a compression manipulation apparatus 340. The compression manipulation apparatus 340 may include any of the compression manipulation apparatuses disclosed herein such as a plurality of converging jets or converging nozzles arranged to converge multiple streams of the hydrocarbon feedstock into a focal point or multiple focal points effective to heat the hydrocarbon feedstock to a temperature above the decomposition temperature of the hydrocarbon feedstock. For example, the jetting or convergent nozzling is used to increase the temperature of the hydrocarbon feedstock through mechanical means. The separate flows of hydrocarbon feedstock are converged to heat the hydrocarbon feedstock. The convergence of two gaseous, high-velocity (e.g., 2 units/sec. to 40 units/sec. or at least 0.1 MMSCFD) hydrocarbon feedstock streams convert high velocity kinetic energy into heat. This rapid increase in heat, as well as a pressure drop through a nozzle, increases the temperature to above the decomposition temperature of the hydrocarbon feedstock (e.g., methane), places the pressure into the decomposition pressure range to initiate pyrolysis, and decreases residence time. The hydrocarbon feedstock undergoes pyrolysis upon the temperature increase and the pressure drop after exiting the compression manipulation apparatus 340.

The converged streams of hydrocarbon feedstock (now undergoing pyrolysis) may be directed into stagnation tank 350. The pyrolysis may complete in the stagnation tank.

The block 430 of converging streams of the pressurized and heated hydrocarbon feedstock effective to initiate pyrolysis of the hydrocarbon feedstock to produce hydrogen gas and carbon black may be omitted in some examples.

The block 440 of separating the hydrogen gas from the carbon black may be carried out in the stagnation tank as disclosed above with respect to the method 200. For example, the carbon black may settle out of the hydrogen gas in the stagnation tank. The hydrogen gas may separate from the heavier unreacted hydrocarbon feedstock.

The pressure and temperature of the stagnation tank 350 may be relatively similar, if not the same, as the exit parameters of the main adiabatic compression chamber 330. Accordingly, the adiabatic compression manipulation apparatus 340 and the associated block 430 may be omitted in some examples. If the adiabatic compression manipulation apparatus is utilized in block 430, a lower pressure and temperature could be used in the stagnation tank 350 as long as such lower pressure and temperature is selectively controlled to be sufficient to induce pyrolysis. With the stagnation tank 350, the primary reaction occurs with the principal chemical reaction resulting in a portion of the hydrocarbon feedstock being separated into hydrogen and carbon black. Within the stagnation tank 350 from which hydrocarbon feedstock is constantly being injected into, the hydrogen gas and carbon black may be actively removed.

Upon removal, the hydrogen gas and the carbon black will be lowered to a temperature and pressure below that which would otherwise induce decomposition. For example, the separation of hydrogen and carbon black in the stagnation tank 350, may be carried out with baffles therein such that sufficient residence time is achieved before separation from the hydrocarbon feedstock or hydrogen gas and carbon black mix. After achieving a desired residence time, the composition of the stagnation tank 350 will include hydrogen gas, carbon black, a quantity of original unreacted hydrocarbon feedstock (e.g., that did not undergo decomposition), and derivative molecular combinations. The product composition may also include impurities.

The method 400 may include block 450 of collecting the hydrogen gas and the carbon black. Collecting the hydrogen gas and the carbon black may include one or more of syphoning hydrogen from an upper portion of the stagnation tank or collecting the carbon black from a bottom of the stagnation tank.

In examples, the carbon black and unreacted hydrocarbon feedstock may be removed to a heavy gas catch 360. The hydrogen gas and unreacted hydrocarbon feedstock may be removed to a light element catch 370, such as from an upper portion of the stagnation tank 350 after the heavier unreacted hydrocarbon feedstock and carbon black fall to the lower region of the stagnation tank 350.

The method 400 may include a block of solids processing and heavy gas reprocessing, such as recirculating the unreacted hydrocarbon feedstock to the step-up chamber 320 for reprocessing. For example, the unreacted hydrocarbon feedstock may be directed through a pressure reducer 318 and residence tank 319 for reprocessing in the step-up chamber 320. Solids processing and heavy gas reprocessing may include packaging the carbon black for sale or use.

The method 400 may include the block gas processing and refinement. Gas processing and refinement may include separating the hydrogen gas from any other light gases produces during pyrolysis. Gas processing and refinement may include using the hydrogen gas or storing the hydrogen gas for use or sale.

The method 400 may include the block 410 of introducing the hydrocarbon feedstock into the step-up chamber 320 such as via inlet 310 at a pressure above atmospheric. To achieve this pressure, compression may be used if a feed supply line is not adequately pressurized.

The method 400 may include recirculating unreacted hydrocarbon feedstock for reprocessing, such as from one or more of the gas processing and refinement or solids processing and heavy gas reprocessing blocks.

Each block of the method 400 is carried out continuously. Such continuous operation is not possible without controlling the pressure, temperature, and velocity of the hydrocarbon feedstock through the main adiabatic compression chamber 330 and/or optional adiabatic compression manipulation apparatus 340 to prevent the pyrolysis reaction from occurring therein (beyond a negligible amount).

Components or aspects of any of the methods or systems herein may be used with other methods or systems disclosed herein, without limitation. While various aspects and embodiments have been disclosed herein, other aspects and embodiments are contemplated. The various aspects and embodiment disclosed herein are for purposes of illustration and are not intended to be limiting.

1. A method for pyrolyzing a hydrocarbon feedstock, the method comprising:
elevating a pressure of the hydrocarbon feedstock to an elevated pressure above a decomposition pressure range of the hydrocarbon feedstock;
heating the hydrocarbon feedstock to at least a decomposition temperature of the hydrocarbon feedstock at the elevated pressure; and
rapidly expanding the heated and pressurized hydrocarbon feedstock to allow pyrolysis to take place to produce hydrogen gas and carbon black.

2. The method of claim 1 wherein elevating a pressure of the hydrocarbon feedstock to above a decomposition pressure range of the hydrocarbon feedstock includes elevating the pressure of the hydrocarbon feedstock to at least 0.69 MPa.

3. The method of claim 1 wherein elevating a pressure of the hydrocarbon feedstock to above a decomposition pressure range of the hydrocarbon feedstock includes elevating the pressure of the hydrocarbon feedstock to at least 6.98 MPa.

4. The method of claim 1 wherein heating the hydrocarbon feedstock to at least a decomposition temperature of the hydrocarbon feedstock at the elevated pressure includes heating the hydrocarbon feedstock to a decomposition temperature of methane in the hydrocarbon feedstock.

5. The method of claim 1 wherein heating the hydrocarbon feedstock to at least a decomposition temperature of the hydrocarbon feedstock at the elevated pressure includes heating the hydrocarbon feedstock to at least 700° C.

6. The method of claim 1 wherein heating the hydrocarbon feedstock to at least a decomposition temperature of the hydrocarbon feedstock at the elevated pressure includes heating the hydrocarbon feedstock to at least 1,000° C.

7. The method of claim 1 wherein rapidly expanding the heated and pressurized hydrocarbon feedstock to allow pyrolysis to take place to produce hydrogen gas and carbon black includes flowing the heated and pressurized hydrocarbon feedstock through one or more rapid expansion valves.

8. The method of claim 1 wherein rapidly expanding the heated and pressurized hydrocarbon feedstock to allow pyrolysis to take place to produce hydrogen gas and carbon black includes flowing the heated and pressurized hydrocarbon feedstock into a reaction chamber.

9. The method of claim 1, further comprising pre-pressurizing the hydrocarbon feedstock to an intermediate pressure prior to elevating the pressure of the hydrocarbon feedstock to above a decomposition pressure range of the hydrocarbon feedstock.

10. The method of claim 9, further comprising pre-heating the hydrocarbon feedstock to an intermediate temperature prior to elevating the pressure of the hydrocarbon feedstock to above a decomposition pressure range of the hydrocarbon feedstock.

11. (canceled)

12. The method of claim 1, further comprising separating the hydrogen gas from the carbon black by flowing rapidly expanded hydrocarbon feedstock into a stagnation tank and allowing the carbon black to fall from hydrogen gas in the stagnation tank.

13. The method of claim 12 wherein separating the hydrogen gas from the carbon black includes separating the hydrogen gas from the carbon black at a temperature of at least 700° C.

14. The method of claim 1, further comprising collecting the hydrogen gas and the carbon black.

15. The method of claim 1, further comprising recirculating unreacted hydrocarbon feedstock to a hydrocarbon feedstock supply for reuse.

16. The method of claim 1 wherein the hydrocarbon feedstock includes one or more of methane, ethane, drill rig vent gases, or well head vent gases.

17. A system for pyrolyzing hydrocarbon feedstock, the system comprising:
a high pressure pump;
a heat exchanger fluidly connected to the high pressure pump;
one or more rapid expansion valves fluidly connected to the heat exchanger; and
a reaction chamber fluidly connected to the one or more rapid expansion valves.

18. The system of claim 17, further comprising a stagnation tank fluidly connected to the reaction chamber.

19. The system of claim 18, further comprising:
a carbon collection apparatus fluidly connected to the stagnation tank; and
a hydrogen collection apparatus fluidly connected to the stagnation tank.

20. The system of claim 17, further comprising:
a hydrocarbon feedstock supply fluidly connected to the high pressure pump; and
a recirculation line fluidly connected to the stagnation tank and a hydrocarbon feedstock supply.

21. The system of claim 17, further comprising:
an initial heat exchanger fluidly connected to the high pressure pump; and
a low pressure pump fluidly connected to the initial heat exchanger and the hydrocarbon feedstock supply.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)
